(19) United States
(12) Patent Application Publication
(10) Pub. No.: US 2004/0210430 A1
(43) Pub. Date: Oct. 21, 2004

(54) PS2 simulator

(75) Inventors: Cherng-Ying Ying, Taipei (TW); Ta-Lung Yu, Taipei (TW)

Correspondence Address: BRUCE H. TROXELL, 5205 LEESBURG PIKE, SUITE 1404, FALLS CHURCH, VA, 22041, US

(73) Assignee: Action Star Enterprise Co., Ltd.

(21) Appl. No.: 10/414,399

(22) Filed: Apr. 16, 2003

(51) Int. Cl. G06F 17/50; G06F 13/00

(52) U.S. Cl. 703/14; 710/62

(57) ABSTRACT

The present invention discloses a PS2 simulator installed at a PS2 interface of a computer so as to simulate signals from a keyboard and a mouse such that the computer using an earlier OS version is booted after one of the signals is detected. Therefore, a KVM switching device based on other interface specifications such as USB and IEEE 1394 can be used.

### BACKGROUND OF THE INVENTION

1. Field of the Invention

The present invention generally relates to a PS2 simulator and, more particularly, to a simulator installed at a PS2 interface of a computer such that the computer using an earlier OS version is booted after the simulator is detected.

2. Description of the Prior Art

Computers have been the most indispensable tools for all kind of purposes from individuals to enterprises. No one can imagine how this world would become of without computers. Moreover, with the rapid development in multi-media, local-area network (LAN) and Internet, the A/V (audio/video) systems used for computers have attracted considerable attention. For an Internet service provider (ISP), a management information system (MIS), etc., multiple computers or multiple servers are usually needed to achieve sharing and allocation of data base. In the prior art, a plurality of computers are coupled to input terminals of a KVM (keyboard, video display and mouse) switching device, which comprises a plurality of switches corresponding to the computers. One of these switches is selected to determine a corresponding computer to output the data such that Internet service as well as management information can be provided.

However, when a computer using an earlier OS version (such as WINDOWS 95 and WINDOWS 98) is booted, a keyboard or a mouse has to be plugged into the communication ports (COM1 and COM2) or the PS2 ports in advance such that the basic input/output system (BIOS) can allow the computer to be booted. For a KVM switching device based on other interface specifications such as USB and IEEE 1394, since the keyboard and the mouse are not plugged into the PS2 ports such that the KVM switching device can not be used. This is the reason why there has not been any non-PS2 based KVM switching device. However, in order to improve the performance of the computer, high-speed interface specifications such as USB and IEEE 1394 are necessary even for the KVM switching device.

Therefore, there is need in providing a PS2 simulator such that a computer using an earlier OS version can be booted when a non-PS2 based KVM switching device is used.

### SUMMARY OF THE INVENTION

In view of the aforementioned issue, it is the primary object of the present invention to provide a PS2 simulator installed at a PS2 interface of a computer so as to simulate signals from a keyboard and a mouse such that the computer using an earlier OS version is booted after one of the signals is detected. Therefore, a KVM switching device based on other interface specifications such as USB and IEEE 1394 can be used.

In order to achieve the foregoing object, the present invention provides a PS2 simulator, comprising: an oscillation circuit, providing an oscillation frequency as an operation frequency; a simulation signal processor, receiving the operation frequency from the oscillation circuit so as to generate and output a first operation signal and a second operation signal; a first output circuit, receiving the first operation signal from the simulation signal processor so as to couple to a keyboard port; and a second output circuit, receiving the second operation signal from the simulation signal processor so as to couple to a mouse port.

It is another object of the present invention to provide a PS2 simulator that can simulate signals from the PS2 interface such that the computer using an earlier OS version can be booted. Therefore, the keyboard and the mouse based on the lower-speed PS2 interface can be replaced by those based on high-speed interface specifications such as USB and IEEE 1394.

In order to achieve the foregoing object, the present invention provides a PS2 simulator coupled to a KVM switching device, wherein a plurality of computers are connected to the KVM switching device as so to select one of the plurality of computers, characterized in that the PS2 simulator is installed at a PS2 interface of a computer so as to simulate signals from a keyboard and a mouse such that the computer using an earlier OS version is booted after one of the signals is detected such that the KVM switching device can be used.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a perspective view showing a PS2 simulator inserted into a PS2 port of a computer according to the present invention;

FIG. 2A to FIG. 2D are detailed circuit diagrams of a PS2 simulator according to the present invention;

FIG. 3 is a flow chart showing the operation of the PS2 simulator according to the present invention; and

FIG. 4 is a perspective view showing a plurality of computers coupled to a PS2 simulator so as to use a KVM switching device the present invention.

### DETAILED DESCRIPTION OF THE INVENTION

The present invention providing a PS2 simulator can be exemplified by the preferred embodiment as described hereinafter.

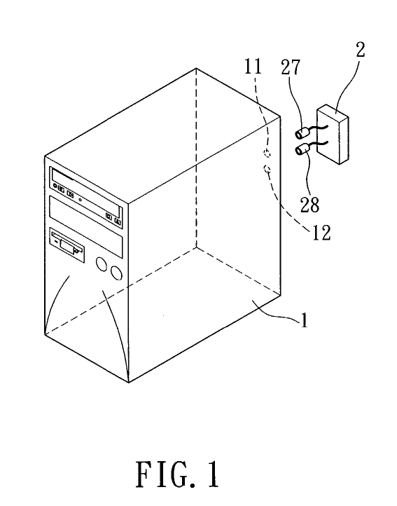

Please refer to FIG. 1, which is a perspective view showing a PS2 simulator inserted into a PS2 port of a computer according to the present invention. A first PS2 port 11 and a second PS2 port 12 connected to a keyboard and a mouse, respectively, are disposed on the back side of a computer 1. When a computer using an earlier OS version (such as WINDOWS 95 and WINDOWS 98) is booted, a keyboard or a mouse has to be plugged into the PS2 ports in advance such that the basic input/output system (BIOS) can allow the computer to be booted. For a KVM switching device based on other interface specifications such as USB and IEEE 1394, since the keyboard and the mouse are not plugged into the PS2 ports such that the KVM switching device can not be used. However, in the present invention, a first PS2 connector 27 and a second connector 28 for a PS2 simulator 2 are plugged into the first PS2 port 11 and the second PS2 port 12, respectively. Therefore, the PS2 simulator 2 simulates the operation signals of the keyboard and the mouse such that the computer using an earlier OS version can be booted and a PS2-based KVM switching device can thus be used. On the other hand, the PS2 simulator simulates the PS2-based signals and transmits the signals to the OS and, therefore, the PS2-based keyboard and the PS2-based mouse can be replaced by a keyboard and a mouse based on high-speed interface specifications such as USB and IEEE 1394. In this manner, the performance of the computer is improved.

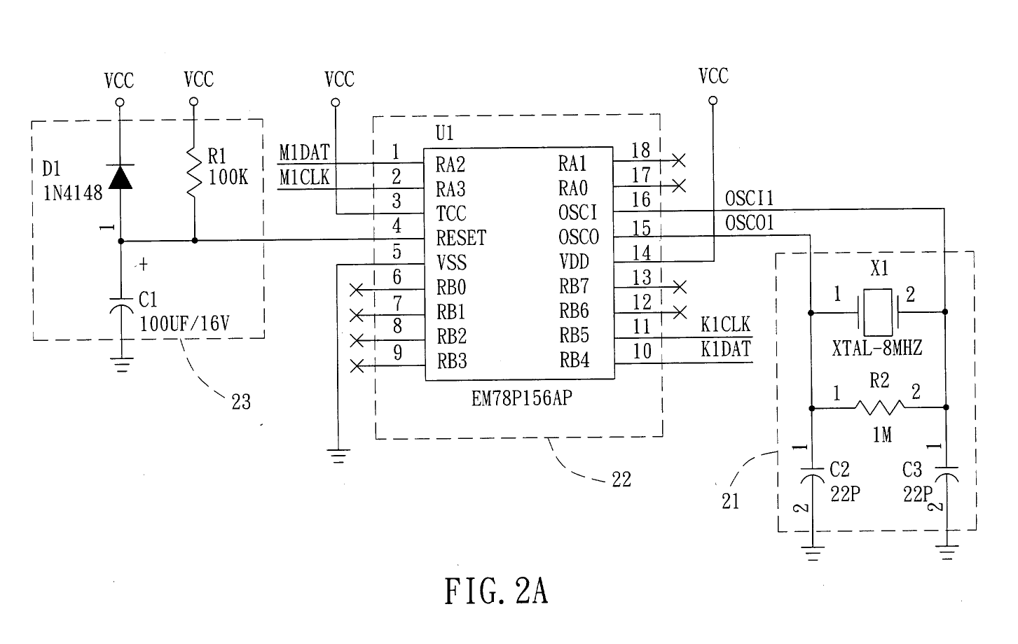

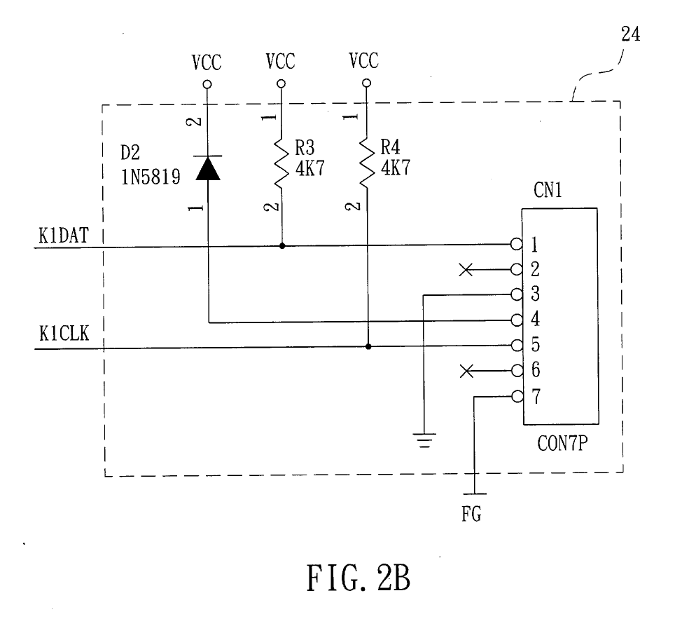

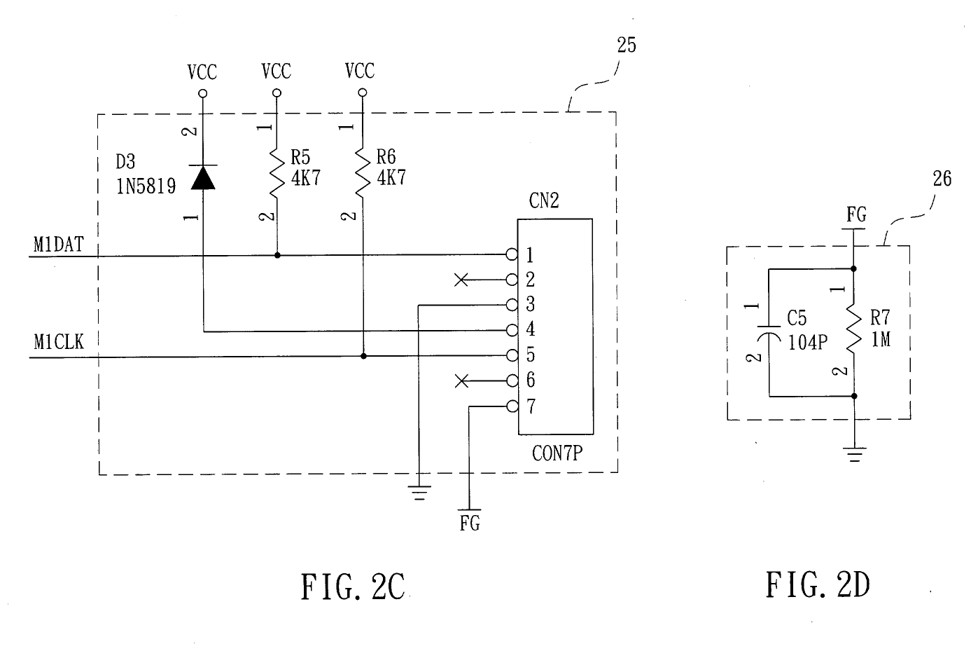

Please refer to FIG. 2A to FIG. 2D, which are detailed circuit diagrams of a PS2 simulator according to the present invention. The PS2 simulator comprises: an oscillation circuit 21; a simulation signal processor 22; a reset circuit 23; a first output circuit 24; a second output circuit 25; a grounding circuit 26; and two connectors 27 and 28. The oscillation circuit 21 provides an oscillation frequency as an operation frequency and is electrically connected to a pin of the simulation signal processor 22. Moreover, the simulation signal processor 22 is electrically connected to the reset circuit 26 so as to provide a reset operation when the PS2 simulator is mal-functional. The simulation signal processor 22 is connected to the first output circuit 24 via two signal lines K1CLK and K1DAT. The first output circuit 24 receives a first operation signal from the simulation signal processor 22 so as to couple to a keyboard port via the first connector 27. Similarly, the simulation signal processor 22 is connected to the second output circuit 25 via two signal lines M1CLK and M1DAT. The second output circuit 25 receives a second operation signal from the simulation signal processor 22 so as to couple to a keyboard port via the second connector 28. In FIG. 2C and FIG. 2D, the FG pin of the first output circuit 24 and the FG pin of the second output circuit 25 are connected to a The internal noise signals inside the PS2 simulator are grounded via the FG pin of the first output circuit 24 and the FG pin of the second output circuit 25, both connected to a grounding circuit 26.

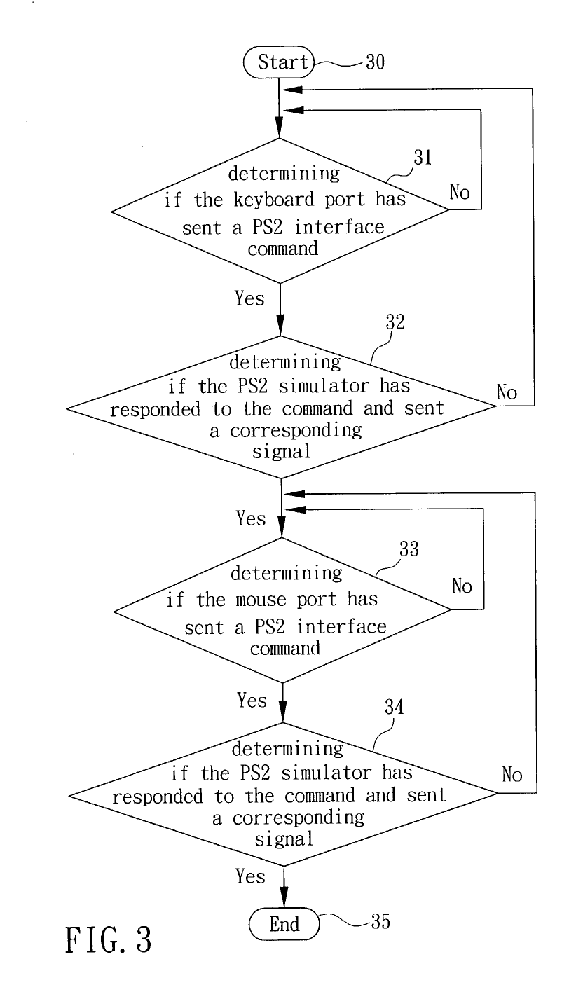

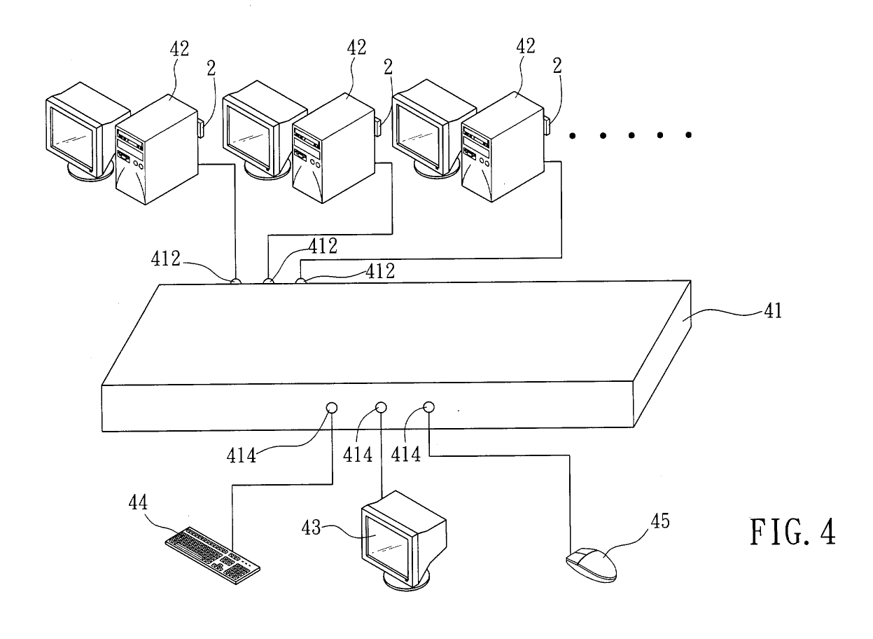

Please refer to FIG. 3, which is a flow chart showing the operation of the PS2 simulator when the PS2 simulator 2 is connected to the computer 1. The operation comprises steps of:

Step 1: Start 30.

Step 2: Determining if the keyboard port has sent a PS2 interface command 31—if yes, proceeding with Step 3; if no, repeating Step 2.

Step 3: Determining if the PS2 simulator has responded to the command and send a corresponding signal 32—if yes, proceeding with Step 4; if no, returning to Step 2.

Step 4: Determining if the mouse port has sent a PS2 interface command 33—if yes, proceeding with Step 5; if no, repeating Step 4.

Step 5: Determining if the PS2 simulator has responded to the command and sent a corresponding signal 34—if yes, proceeding with Step 6; if no, returning to Step 4.

Step 6: End 35.

Please further refer to FIG. 4, which a perspective view showing a plurality of computers coupled to a PS2 simulator so as to use a KVM switching device the present invention. In FIG. 4, there are a plurality of computers 42 connected to a plurality of corresponding input terminals 412 of the KVM switching device 41. On each of the computer 42 is provided a PS2 simulator 2, as shown in FIG. 1. On the KVM switching device 41 are provided a plurality of switches (not shown) corresponding to the computers 42 so as select and output the signal from one of the computers 42. The signal is then processed by the KVM switching device 41 and thus the KVM switching device 41 outputs a KVM signal including a keyboard signal, a video display signal and a mouse signal to be transmitted to a keyboard, a video display and a mouse, respectively. By using this configuration, the PS2 simulator disposed on each of the computers 42 simulates the PS2-based keyboard signal and the PS2-based mouse signal such that the BIOS can detect the simulated signals and allow the computer to be booted. Therefore, the KVM switching device based on high-speed specifications such as USB and IEEE 1394 can be used on the computer even if the computer uses an earlier OS version (for example, Windows 95 or Windows 98). In this manner, an improved configuration, in which an early OS can be used with other high-speed non-PS2 based KVM switching device so as to reduce the cost and improve the overall performance.

According to the above discussion, the present invention discloses a PS2 simulator installed at a PS2 interface of a computer so as to simulate signals from a keyboard and a mouse such that the computer using an earlier OS version is booted after one of the signals is detected. Therefore, the present invention has been examined to be novel, unobvious and useful.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A PS2 simulator, comprising:
an oscillation circuit, providing an oscillation frequency as an operation frequency;
a simulation signal processor, receiving said operation frequency from said oscillation circuit so as to generate and output a first operation signal and a second operation signal;
a first output circuit, receiving said first operation signal from said simulation signal processor so as to couple to a keyboard port; and
a second output circuit, receiving said second operation signal from said simulation signal processor so as to couple to a mouse port.

2. The PS2 simulator as recited in claim 1, wherein said simulation signal processor is electrically connected to a reset circuit so as to provide a reset operation when said PS2 simulator is mal-functional.

3. The PS2 simulator as recited in claim 1, wherein said first output circuit is connected to a grounding circuit so as to ground internal noise signals of said PS2 simulator.

4. The PS2 simulator as recited in claim 1, wherein said second output circuit is connected to a grounding circuit so as to ground internal noises signals of said PS2 simulator.

5. The PS2 simulator as recited in claim 1, wherein said first output circuit is connected to a first PS2 interface connector.

6. The PS2 simulator as recited in claim 1, wherein said second output circuit is connected to a second PS2 interface connector.

7. A PS2 simulator coupled to a KVM switching device, wherein a plurality of computers are connected to said KVM switching device as so to select one of said plurality of computers, characterized in that said PS2 simulator is installed at a PS2 interface of a computer so as to simulate signals from a keyboard and a mouse such that said computer using an earlier OS version is booted after one of said signals is detected such that said KVM switching device can be used.

8. The PS2 simulator coupled to a KVM switching device, wherein said KVM switching device is connected to a USB interface.

9. The PS2 simulator coupled to a KVM switching device, wherein said KVM switching device is connected to an IEEE 1394 interface.
